(19) United States
(12) Patent Application Publication
(10) Pub. No.: US 2008/0027917 A1
(43) Pub. Date: Jan. 31, 2008

(54) Scalable Semantic Image Search

(75) Inventors: Saikat Mukherjee, North Brunswick, NJ (US); Shaohua Kevin Zhou, Plainsboro, NJ (US); Xiang Zhou, Exton, PA (US); Martin Huber, Uttenreuth (DE); Jorg Freund, Munich (DE); Volker Tresp, Munich (DE); Sonja Zillner, Munich (DE); Alok Gupta, Bryn Mawr, PA (US); Dorin Comaniciu, Princeton Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/767,920

(22) Filed: Jun. 25, 2007

Related U.S. Application Data
(60) Provisional application No. 60/820,854, filed on Jul. 31, 2006.

(51) Int. Cl. G06F 17/30

(52) U.S. Cl. 707/3; 707/E17.019

(57) ABSTRACT

A computer-implemented system for searching a plurality of images for an image of interest including a database of semantic image representations corresponding to the plurality of images, wherein the semantic image representations link a semantic model of clinical properties, a syntactic model of high level image properties and an image vocabulary of low level image properties, a set of queries associated with the semantic image representations, and a semantic search engine, embodied as computer readable code executed by a processor, for receiving a search query, selecting at least one of the set of queries based on the search query, and searching the plurality of images for the image of interest by comparing the plurality of images against the semantic image representations associated with a selected query.

### CROSS-REFERENCE TO RELATED APPLICATION

This application claims priority to U.S. Provisional Application Ser. No. 60/820,854, filed on Jul. 31, 2006, which is herein incorporated by reference in its entirety.

### BACKGROUND OF THE INVENTION

1. Technical Field

The present invention relates to searching, and more particularly to a system and method for scalable semantic image searching.

2. Discussion of Related Art

Medical imaging, is becoming more important due to improvements in technology. These improvements have occurred in areas including multi-modality imaging, molecular imagine (e.g., PET-MRI (Positron Emission Tomography-Magnetic resonance imaging, PET-CT (Positron Emission Tomography-Computed Tomography), and the “standard” imaging modalities (e.g., dual-source CT (Computed Tomography)). With increased use of medical imaging due to the availability of different modalities for a single diagnosis, the increase in temporal and spatial resolution, and mass cancer screenings, a commensurate rise in the amount of medical image data generated has been observed.

The healthcare industry is producing increasing amounts of heterogeneous medical information on decentralized information storage systems, e g., at different healthcare providers and/or decoupled IT systems. Challenges from a data/information point of view include how to efficiently deal with the data explosion especially in medical imaging; how to use all available information of the images; how to operate in a heterogeneous and distributed data environment; how to extract information front imaging data; how to generate knowledge from the available data and information; and how to present the retrieved information in a usable way.

Despite advances in image understanding semantic modeling and search technology, intelligent image search remains an academic concept with little or no commercial impact. Current image databases (web-based, medical PACS (Picture Archiving and Communications System) or RIS (Radiology Information System)) are indexed by keywords assigned by humans and not by the image content.

One reason for this slow progress is the lack of scalable and generic information representations capable of overcoming the high-dimensional nature of image data. Indeed, existing “content-based image search and retrieval” applications are focused on the indexing of certain image features that do not generalize well. As a result, the image search technology is not scalable, does not exploit image syntax, and is does not operate at semantic level.

Therefore, a need exists for a system and method for scalable semantic image search.

### SUMMARY OF THE INVENTION

According to an embodiment of the present disclosure, a computer-implemented system for searching a plurality of images for an image of interest comprising a database of semantic image representations linking a semantic model of clinical properties, a syntactic model of high level image properties and an image vocabulary of low level image properties, a set of queries associated with the semantic image representations, and a semantic search engine, embodied as computer readable code executed by a processor, for receiving a search query, selecting at least one of the set of queries based on the search query, and searching the plurality of images for the image of interest by comparing the plurality of images against the semantic image representations associated with a selected query.

According to an embodiment of the present disclosure, a computer readable medium embodying instructions executable by a processor to perform a method for constructing a database of semantic image representations, the method steps including defining hierarchical representations of an image domain, defining a query language comprising a plurality of queries available to a search engine, and associating the queries to the hierarchical representations, wherein the associated queries and hierarchical representations are stored in the database as the semantic image representations.

### BRIEF DESCRIPTION OF THE DRAWINGS

Preferred embodiments of the present invention will be described below in more detail, with reference to the accompanying drawings:

FIG. 1 is a diagram of a system according to an embodiment of the present disclosure;

FIG. 2 is a diagram of a system according to an embodiment of the present disclosure;

FIG. 3 is a table of exemplary combinations of applications of the framework with interested user groups according to an embodiment of the present disclosure;

FIGS. 4A-D are examples of image annotation according to an embodiment of the present disclosure;

FIG. 5A is a flow chart of a method for supporting a semantic image search according to an embodiment of the present disclosure; and

FIG. 5B is a flow chart of a method for defining a hierarchical content representation and query language according to an embodiment of the present disclosure.

### DETAILED DESCRIPTION OF EXEMPLARY EMBODIMENTS

According to an embodiment of the present disclosure, a system and method for semantic intelligent image searching provides direct and seamless access to the informational content of image databases.

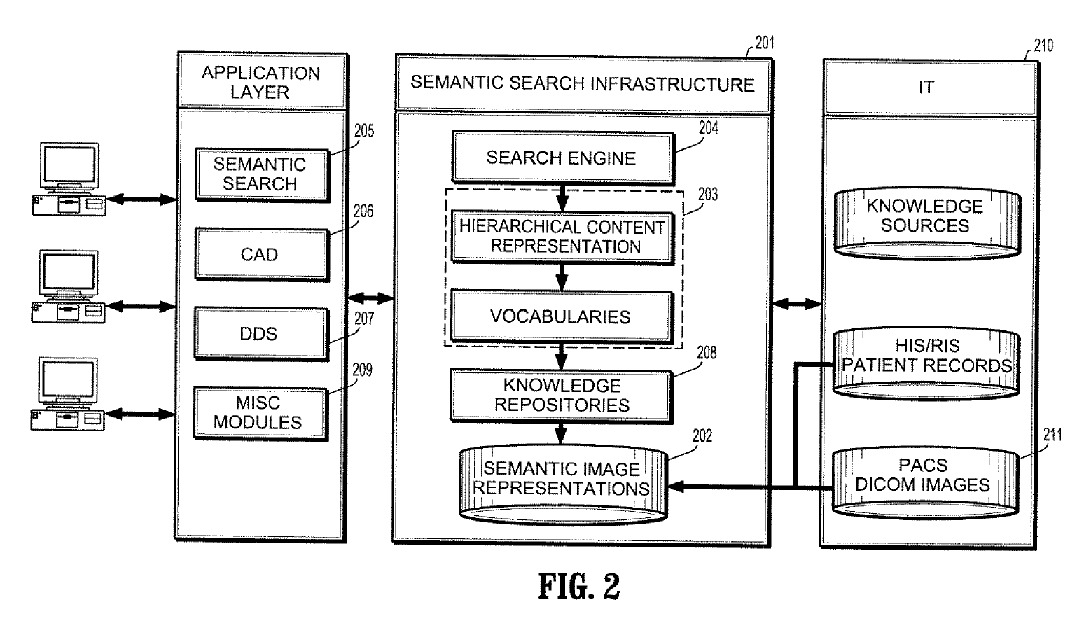

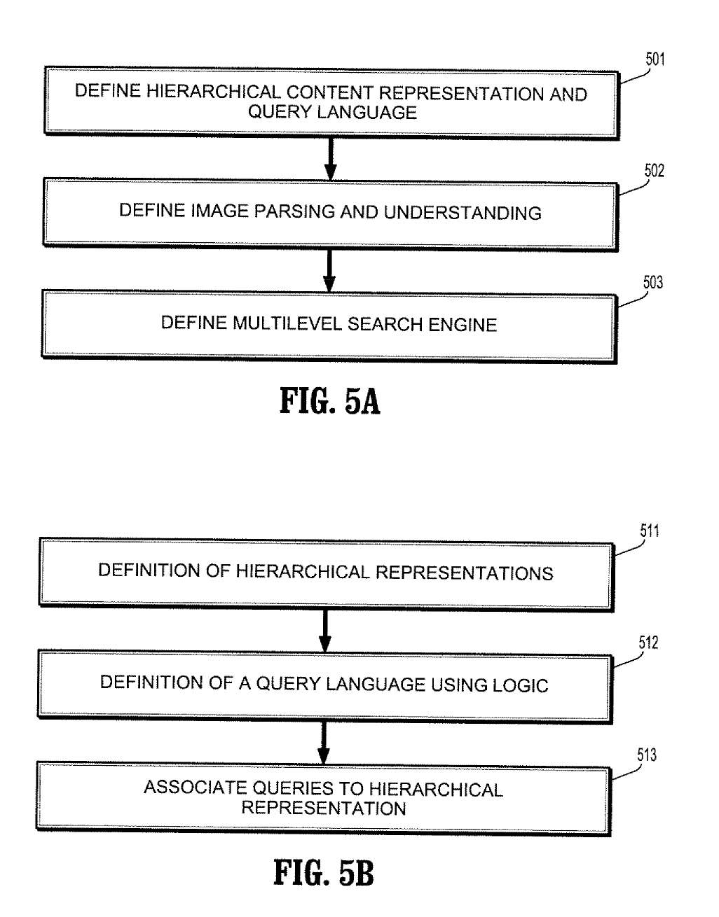

According to an embodiment of the present disclosure, the system (see for example, FIG. 2) includes means for constructing hierarchical information representations for facilitating flexible image queries (see for example, FIG. 5B). The system exploits intrinsic constraints of the imaging domain (e.g., medical image domain) to mine and define a substantially complete set of queries, integrates higher level knowledge represented by ontologies for explaining different semantic views on the same image (including for example, structure, function, and disease), and uses competencies in semantics and image understanding to formally build a bridge between the imaging and knowledge domains. This cross-layer research approach is applied in a quasi-generic image search.

Exemplary embodiments of the present disclosure are described with reference to a medical imaging domain, wherein the system and method fills a gap between image searching using indexing by keywords and the needs of modern health provision and research by providing direct, semantic access to medical image databases.

Embodiments may be deployed on stand-alone system, grid-based platforms, etc.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

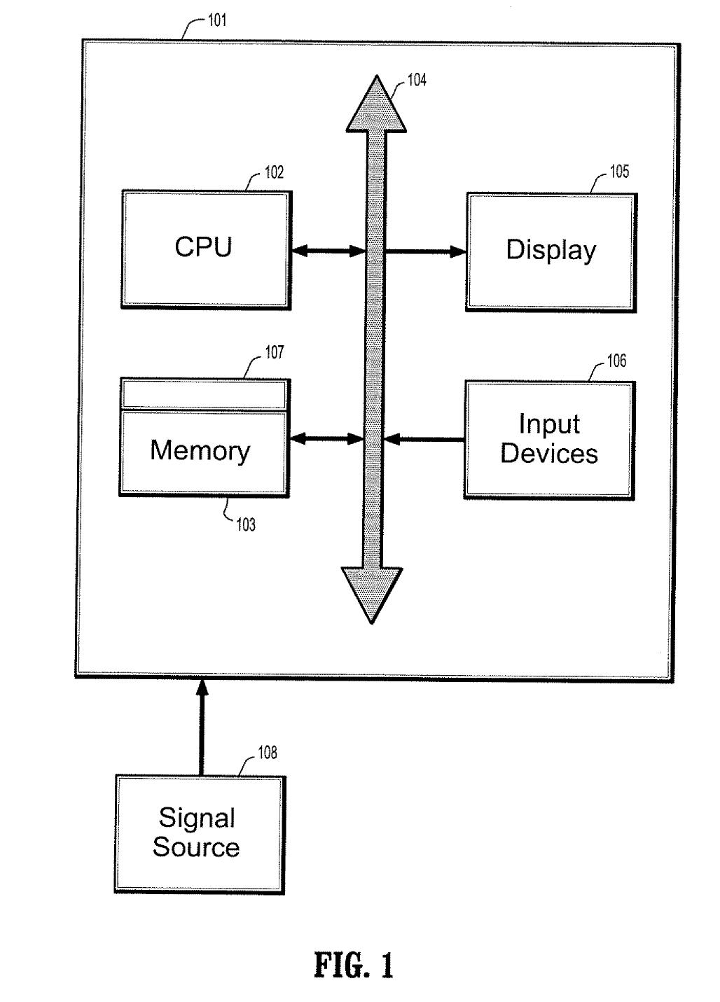

Referring to FIG. 1, according to an embodiment of the present invention, a computer system 101 for implementing a method for scalable semantic image searching comprises, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general-purpose computer system that becomes a specific purpose computer system when executing the routine 107 of the present invention.

The computer platform 101 also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Referring to FIG. 2, according to an embodiment of the present disclosure, the system may be implemented as a plurality of software modules and databases executed and processed by a computer system. Similarly, the software modules may be implemented as a chip. The system includes a semantic image search framework 201 including modules for searching and accessing an image database 2107 such as a PACS database 211, based on content and semantics. The semantic image search framework 201 includes a generic and hierarchical representation of image contents module 202, a generalizable module for image understanding 203, and a reasoning, inference, and discovery engine 204. The framework 201 may further include knowledge repositories 208.

The framework 201 may be augmented with additional functions, implemented as application layer programs including a flexible semantic query support module 205, semantic CAD (computer aided detection and diagnosis) and DSS (decision support system) modules 206 and 207, a scalable and evolving infrastructure 209, etc.

The flexible, semantic query support module 205 of the framework 201 understands human anatomy and function at various scales. It supports queries that are either explicitly or implicitly constrained by spatial or functional relationships. The framework 201 includes models, e.g., disease models in the medical imaging domain, which can support semantic queries with knowledge of the diseases. Such disease models are hierarchical (see FIG. 5A, block 501 and FIG. 5B, block 511), e.g., for example, following the International Classification of Diseases (ICD), and may encode organ interactions, e.g., the organs of the cardiovascular system. Flexible queries can be constructed (see FIG. 5A, block 501) in terms of disease type, location, interaction with multiple organs, with evolution in time (e.g., cancer staging), etc.

The semantic CAD and DSS modules 207 and 208 are parameterized and executed in real-time to provide probabilistic assertions during the querying process of the semantic query support module 205, enabled by an augmented ontology with embedded discriminative learning machines.

The knowledge repositories 208 include associated hierarchical ontology and semantic annotations and promote new knowledge applications.

The framework 201 is sealable and adaptable by design, expands in both scale and scope for multimedia search in different domains using different pluggable modules.

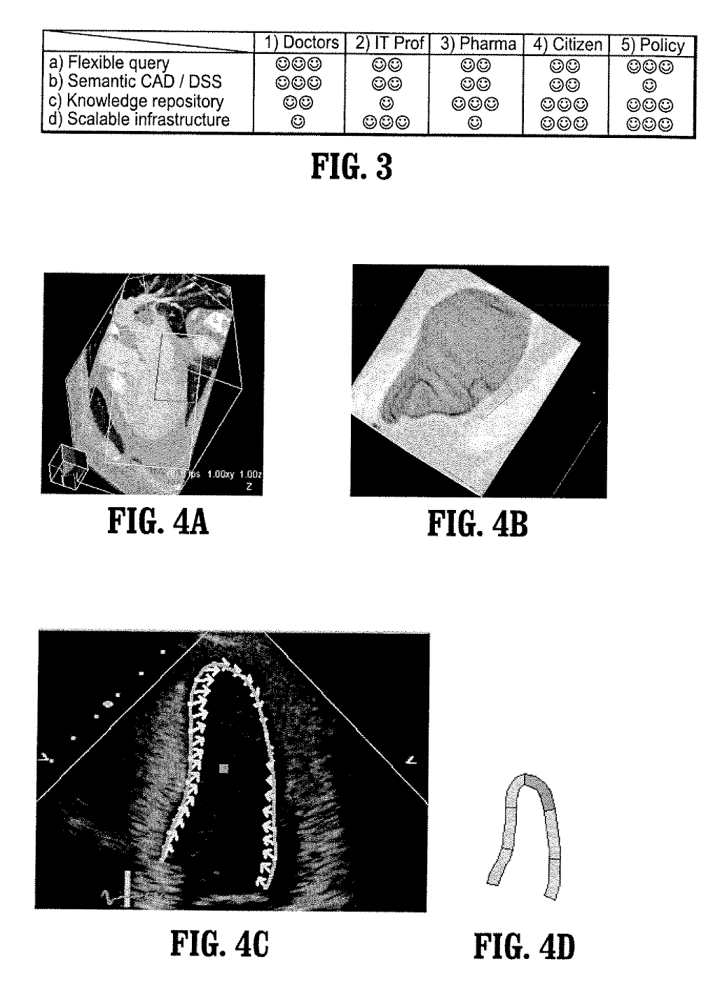

FIG. 3 illustrates exemplary combinations of applications of the framework with different groups of exemplary users. Each scenario has a different value proposition for the respective user group, for example, flexible query and semantic CAD/DDS are important to doctors.

The generic and hierarchical representation of image contents module 202 will now be described in connection with an exemplary implementation in the medial image domain. The generic and hierarchical representation of image contents module 202 injects meaning into, and adds relationships among, medical image contents. The generic and hierarchical presentation of image contents module 202 supports linking of models of the generalizable module for image understanding 203, e.g., the semantic models, syntactic models and vocabularies. The linking of models (see FIG. 5B, block 513) incorporates anatomical, functional and biological structures or processes of the human body with contents extractable from heterogeneous medical images and the capturing of evolutions of the hierarchy, for example, the physiological and pathological changes of the human body, evolving imaging technology, and discovery of new medical knowledge.

For query pattern mining (see FIG. 5B, block 512) performed by the generalizable module for image understanding 203 there is a semantic gap between low-level image features and techniques for complex pattern recognition. To create a formal fusion of semantic representation and image understanding to bridge the semantic gap for supporting more flexible and scalable queries, the hierarchical content representation and query language define components including a representation language, a query language and an integration on ontologies. The representation language models hierarchical semantic content. The query language is coupled with the representation language and facilitates complex and flexible queries. The integration of different ontologies facilitates the querying and understanding of images from several dimensions.

The definition of image semantics within a constrained domain is useful for the mining. In the context of medical imaging, image semantics need to be defined for pars of human anatomy. Within a constrained domain the semantics of a concept is defined by the queries associated with it, grounding the image semantics. By using a constrained domain, the looseness of subjective semantics and the risk of over abstraction are substantially avoided. By focusing on a constrained domain, for example, medical imaging, a set of queries is implemented (e.g., provided or learned) for each concept (part) of the human anatomy, e.g., providing a set of queries for cardiac structure. The queries for each concept or part include indications of image detectors/recognizers particular to the concept of part. The recognizers constitute the image semantics for the anatomical part.

A source of information for learning queries can include medical knowledge bases and clinical reports. Medical knowledge repositories, such as clinical books, journals, etc., contain information on image-centric questions relative to different body parts of interest to physicians. For example, queries of the heart could be about image analysis of left ventricle, right ventricle, etc. Similar information also exists in physician reports, laboratory notes, etc.

The generalizable module for image understanding 203 extracts image-centric information from medical texts automatically and forms the query patterns (see FIG. 5B, block 512). The information extraction can be achieved with known technologies from natural language text. The result of this work has been the development of mature technologies for automatic or semi-automatic extraction of salient information from text. Further, text may be analyzed for learning question patterns, which are subsequently used for improving the information retrieval process.

While the process of query pattern mining might need the involvement of domain experts, such as physicians, it is worth underlying the value of learning-based automated techniques for this purpose. Since domain knowledge continually evolves, with newer medical discoveries, it is important to have a process that can perform automated question pattern discovery.

According to an embodiment of the present disclosure, semantic imaging is grounded to the semantics of a human anatomical concept to a set of queries associated with it. The constrained domain of a human body enables us to have a rich coverage of these queries and, consequently, define image semantics at various levels of the hierarchy of the human anatomy. The package is about representation languages or vocabularies (see FIG. 2, block 203) for modeling the hierarchical organization as well as image semantics.

The modeling needs of the representative language (see FIG. 2, block 203) may be met with the use of ontologies as knowledge repositories 208. Ontologies are a branch of artificial intelligence dealing with formal modeling of domain semantics. Research on the Semantic Web has resulted in languages such as RDFS (Resource Description Framework Schema) and OWL (Web Ontology Language) for ontology representation. In the vision of the Semantic Web, documents would be annotated with semantic metadata using ontologies represented in these languages.

The representative language implements a physics-based hierarchy of human anatomy as a semantic backbone for formal semantic modeling. The features of the representation language include ontologies expressed in RDFS and OWL for modeling an image hierarchy, a generic representation mechanism, the ability to evolve and formulating rules.

Referring to the use of ontologies expressed in RDFS and OWL for modeling an image hierarchy; RDFS provides language support for modeling resources (categories), properties, and constraints on properties for specifying subclass relationships and domain and range. OWL extends RDFS with language constructs for specifying further constraints such as cardinality, value, relationships between properties, and specifying concept instances. OWL, in particular, is grounded on formal description logic foundations, which provide the framework for not only hierarchical representation but also computationally tractable logical reasoning. The use of logical reasoning through a hierarchy allows queries formulated on abstract features to be answered with images annotated with specific features.

The representation mechanism is generic; an immediate application is to medical imaging. The Foundation Model of Anatomy (FMA), a rich and detailed anatomical decomposition of the human body, has been modeled as an OWL ontology. This module enriches the concepts in the FMA ontology with additional properties that are linked to the query patterns for respective anatomical parts. As a result, human body concepts, such as the “left ventricle of the heart,” will be associated with ontological properties of image descriptors. These image descriptors could be associated to primitive image features or to more complex recognizers specially trained for detecting the particular anatomical part.

The flexible knowledge representation has the ability to evolve. Knowledge of any domain is dynamic. For example, in the medical domain new diseases, new remedial actions, newer methods of image analysis, etc. emerge constantly. Thus, the ontologies, as knowledge representation vehicles 208, may evolve with the knowledge.

The representation of the image ontology as well as the extension of FMA with image properties can involve formulating rules. Moreover, rules are also important in diagnosis. The knowledge repository module 208 supports representing rules within the framework 201.

Referring now to the query language definition (see FIG. 5B, block 512) as a component of the query pattern mining; users can query either through images or through keywords associated with semantic concepts. When querying by images, an image parser extracts abstract image concepts, which are subsequently sent to the retrieval system for matches against the database of images.

When querying by keywords, users directly enter keywords mapped to ontology concepts. The keyword-based querying according to an embodiment of the present disclosure maps keywords to ontological concepts and using the semantics to infer implicit results. This allows for the retrieval of images that are not annotated explicitly with the query concepts but with concepts related to them through the ontology.

The features of the query language include expressing image annotation, query language support, and reasoning engines.

For expressing image annotation, a Resource Description Framework (RDF) is used for describing these annotations. RDF is a flexible language for representing metadata, which has been standardized by the Semantic Web efforts. A RDF annotation is a triple, which links a pair of resources with a property. These resources and properties could be described in terms of other resources and properties. RDFS and OWL, as languages for ontologies, provides their semantic interpretation.

Referring to the query language support of the generalizable module for image understanding 203; just as a language like SQL is needed to query relational databases, special purposes languages are also needed for querying metadata annotated with ontology concepts. An ontology-based query languages for image retrieval are known in the art. Query language support according to an embodiment of the present disclosure may use, for example, OWL-QL, an emerging standard for querying OWL annotated metadata. This suits the use of OWL and RDFS as the knowledge representation languages.

Referring to the reasoning engines, which are implemented by generalizable module for image understanding 203; the ability to infer implicit information through explicit annotation and the ontological semantics is important to complex querying. According to an embodiment of the present disclosure, the reasoning engine performs inferencing. Since OWL is based on description logic (DL) formalisms, the reasoning engines may use DL reasoners such as Racer and FaCT for this purpose.

In the semantic medical imaging application, complex queries will involve image concepts as well as human body concepts drawn from the FMA ontology. Due to the complexity and number of concepts in FMA, current DL reasoners are unable to work with the whole ontology. This module incorporates techniques for efficient DL reasoners for supporting complex reasoning. As the FMA is integrated with other ontologies, such as ICD for diseases, efficient and tractable reasoning will be important.

In the medical domain, often there is a need for probabilistic annotation of semantic metadata. Existing description logic based ontologies are fully deterministic and do not support probabilistic concept instances. The query language leverages upon work in probabilistic description logic for reasoning with fuzzy annotations. The objective is to investigate the feasibility of these approaches within the OWL framework without significant sacrifices on tractable reasoning.

Complex queries can be better answered in the presence of additional rules that can specify richer prerequisites for inferencing. However. OWL-based description logics do not permit explicit rule bases. The query language incorporates rules within OWL ontologies. These rules could also be associated with probabilities.

Referring now to ontology integration; the platform synergizes semantic information from different dimensions to provide better medical search. In modern medicine, diagnosis is performed using a variety of data sources such as images, anatomical relationships between organs, functional characteristics, genomic and proteomics data, disease association of organs, etc. Different kinds of information are described using their respective ontologies. For example, the ICD (International Classification of Diseases) is an ontology of diseases, while the GO (Gene Ontology) is an ontology of genes, SNOMED (Systemized Nomenclature of Medicine) and UMLS (Unified Medical Language System) for clinical vocabularies and term relationships, etc. This module integrates diverse medical ontologies with the anatomical FMA (Foundational Model of Anatomy) to facilitate search on multiple dimensions.

The ontologies may be represented in a uniform language and brought within a common umbrella using a common representation mechanism and association of diverse ontologies. Hence, the focus is on common modeling paradigms. This enables search queries to be expressed and answered using not just anatomical and image concepts but also their association to disease, functional, genomics, etc. concepts.

OWL is a semantic representation platform. The Foundational Model of Anatomy has already been mapped to OWL. Furthermore, the representation of the UMLS medical terminology ontology in OWL and the Gene Ontology has also been represented in OWL. The ontology integration includes features for representing different ontologies in OWL along the lines of GO and UMLS and associating them to the FMA (Foundational Model of Anatomy) to form a common umbrella

This common umbrella can then be seamlessly used in the search. Of particular interest is the association and representation of disease concepts to anatomy since diseases are a prime motivation of medical image analysis. Below are described efforts in disease mapping and characterization.

Referring to disease mapping and characterization; over the past century, human beings have gathered remarkably detailed knowledge of physiology and diseases, including the complete sequencing of the whole human genome.

There have been strong research efforts on building mathematical models of human physiology and disease, for example, translational research exploiting animal to models for human disease modeling (see, for example, the IUPS/EMBS physiome project research at European Molecular Biology Laboratory). A beneficiary of such models is the pharmaceutical industry, which seeks to reduce its skyrocketing drug development cost through in silico simulations or “e-R&D”, where computer can simulate virtual patients developing disease, then undergoing virtual treatment. The resulting in silico responses are used to access treatment efficacy.

Disease mapping and characterization will represent existing models with image contents in the framework's content representation hierarchy. The challenge is in a seamless integration that will facilitate semantic, image-based queries.

To automatically exploit these models in a dynamic image retrieval system, the framework 201 has to be able to “understand” (i.e., to reason about) or, in some cases, manipulate (e.g., simulating different parameters) these models.

Unlike the modeling of healthy human anatomy and function (see for example, FMA, or Foundational Model of Anatomy, a complete ontology of human anatomy), the disease characteristics vary from one disease to another. Therefore, it can be difficult to find a generic representation scheme that can be fitted onto different diseases. The disease maps and associated ontology will be built on top of commonly accepted international classification systems, including the WHO ICD family (International Classification of Diseases) and ICF (International Classification of Functioning, Disability and Health).

There are many types of disease models: structural defect models, pathophysiology models (functional change models), epidemiological models; and after drug intervention: pharmacokinetic models and pharmacodynamic models, etc. Once the types of disease are crossed with the types of models, the resulting combination can be overwhelming for one project to handle. According to an embodiment of the present disclosure, a disease modeling is constrained significantly in scope, with a focus on disease characteristics expressible (either directly or indirectly) only by medical imaging.

Disease mapping and representation includes, for example, systematic representation in which many diseases affect not only local but also distal or overall systematic function, longitudinal representation for representing the evolution of diseases both in space and in time, interactive representation for representing disease interactions with drugs and therapy, personalizable representation in which diseases can be personalized, or more generally, can be customized to sub-groups of population: e.g., male/female, age, ethnic, geographical sub-groups, and integrated or scalable representation for incorporating future inputs from—omics and molecular imaging research.

Referring to image parsing and understanding (see FIG. 5A, block 502), semantic image annotation defines the ground truth through annotating the medical images collected at various sites and is implemented by the reasoning, inference, and discovery engine 204.

Since the medical image content can be interpreted according to various ontological views (structural, functional, disease etc.), the ground truth annotation should be performed at different semantic levels. This induces the need for new annotation tools. For example: At the structural or anatomic levels, the annotations of the shapes of various structures such as organs are needed. FIG. 4A shows how the left ventricle is annotated in the cardiac CT volume, using the landmarks and mesh, respectively. At the disease level, the annotation of the disease type, the loci of the disease, etc. are needed. In FIG. 4B, the annotation of a polyp (a potential precursor of cancer tumor) is presented. At the functional level, according annotations depending on the functional conditions are needed too. FIG. 4C gives an annotation of the segmental motion scores of myocardium needed in analyzing the wall motion of myocardium. FIG. 4C shows the motion score of the myocardium (delineated by the contour in the left image) where the green color (in FIG. 4D) means normal motion and the color red means abnormal motion.

In the process of annotation, we will also collect statistics related to the image data, which are important for pre-processing steps such as image normalization. For example, ultrasound-specific intensity normalization is used to reduce appearance variation before learning the pairwise active appearance models. When the dataset size is small, we will use the bootstrapping technique if necessary to improve the representational power of the available data.

Referring to the image descriptors, generative and discriminative models, and structural and syntactic methods: discovering and defining perceptually relevant representations, or image descriptors, is a low-level computer vision problem. Examples of perceptually relevant representations include edges, color, corners, and textures, to wavelets and filter banks, curvelets, and ridgelets, and affine-invariant interest points (such as SIFT descriptors), salient features, textons and primal sketch, and part. Image descriptors can be learned as well. A sparse code may be learned for natural images.

Again, by constraining the domain, for example, to medical images, the descriptors may also be constrained, thereby offering the opportunity for developing specialized image descriptors. According to an embodiment of the present disclosure, constrained descriptors, which are feature selectors/extractors, are automatically selected.

Based on the low-level image descriptors, e.g., shape and texture, syntactic models for objects are built according to an ontology. The syntactic module differentiates medical objects—while different objects may share the same visual words, it is unlikely that they possess the same syntax. Stochastic processes or generative models are widely used in the literature to integrate the visual words. For example, the Markov Random Field (MRF) image models are introduced to describe the pairwise clique relationship. Two-dimensional Multiresolution Hidden Markov Models (2D MHMMs) are used to integrate low-level wavelet. Perceptual grouping models (mostly of discriminative nature) are applicable too.

Generative graphical models are used to represent the process of combining image descriptors for representing object. Objects are matched to an image using, a number of models for the joint distribution of image regions and words: multi-modal and correspondence extensions to Hierarchical clustering/aspect model, a translation model adapted from statistical machine translation, a multi-modal extension to mixture of latent Dirichlet allocation (MoM-LDA), etc.

The syntactic object can take a holistic representation such as principal component analysis, independent component analysis, or object classifier (binary or multiclass). In particular, object classifier is a class of models: discriminative models. The object-specific classifier is trained to distinguish the object of interest from everything else other than the object.

The aforementioned methods belong to the category of Statistical Pattern Recognition (SPR). In the pattern recognition literature, there is another research stream called Structural and Syntactic Pattern Recognition (SSPR). SSPR is grounded on the fundamental premise that “shape” or “patterns” in any domain (space, space-time, etc.) is encoded by the attributes of parts and their relations in the domain of reference. SSPR methods directly accommodate rich descriptions of structure.

A semantic image parsing and ontological inference is implemented by the search engine 204 for reasoning, inference and discovery. While determining the low-level image descriptors may be done by running generic algorithms such as edge detector, wavelet transform, etc., it can be difficult to directly interpret an image containing several syntactic objects because the image syntax defined in earlier modules are mostly for a single syntactic object, which is object-specific. Therefore, the technique of semantic image parsing may be used to map the medical images to the content representation as earlier defined. In other words, the semantic image parsing technique automatically annotates the medical images into syntactic objects and ontological semantics. Therefore, semantic image parser directly supports the queries that search for the content of a given image and also provides a basis to support the queries that search and rank images in the database with a certain content, which is implicitly specified by an image example.

Image parsing in the psychophysical literature is referred to a task of “intermediate level vision,” which includes our ability to identify objects when they undergo various transformations, when they are partially occluded, to perceive them the same when they undergo change in size and perspective, to put them into categories, to learn to recognize new objects upon repeated encounter, and to select objects in the visual scene by looking at them or reaching for them. To implement an intermediate level vision task by a computer program is challenging with a limited success. An image parsing algorithm may be used to unify segmentation, detection and recognition is proposed based on a Bayesian framework. Example images at containing both pedestrians and texts are presented. Images may be parsed into regions and curves. Domain knowledge may be used to parse news video programs and to index them on the basis of their visual content, and develop models to depict both the spatial structure of image frames and the temporal structure of the entire program for news videos, along with algorithms that apply these models by locating and identifying instances of their elements.

The image parser that parses medical images into syntactic objects and clinical semantics is an immediate task of this work package.

Ontology provides guidance for semantic image parsing. Structural ontology defines what objects to search instead of exhaustive scanning all possible objects. Structural ontology also defines the structural relationship among objects. Utilizing this relationship reduces the search speed. For example, after finishing searching the left ventricle, the location of the right ventricle is more or less know according to heart anatomy. Ontology also provides prior for constructing models for complex objects/semantics. The ontological integration may be used for semantic image parsing for syntactic and semantic constraints.

Understanding the performance of the medical image parser is equally important. For example, uncertainty characterization and extreme value analysis help to interpret the parsing results.

Referring now to methods for image parsing performed by the search engine 204; image parsing is a computationally intensive procedure, especially with the increase in the number of objects/concepts to be parsed. In the statistical computing community, Markov Chain Monte Carlo (MCMC) methods are used to solve optimization tasks. The MCMC methods derive a Markov chain process whose stationary distribution is the target distribution we want to simulate. Data-driven proposals derived from discriminative models may be integrated into MCMC, which solves inference for a generative model, for a faster convergence, when parsing an image into text, face, and other regions. Pyramid image processing is an efficient structure that facilitates real-time vision computation. It starts computation from the coarsest level and propagates results to finer levels. It is widely used in computer vision literature, especially in optical flow computation. On the other hand, multiscale (“multiresolution”, “multilevel”, “multigrid”, etc.) scientific computing methods start computation from a local scale and progress to global scales, i.e., solving a global problem from a local-to-global fashion. The multigrid algorithms have been used to solve vision problems such as detection of curved features, image segmentation, etc. According to an embodiment of the present disclosure, a multigrid algorithm is used in medical applications.

Vision problems often reduce to optimization in a high-dimensional parameter space. For example, a left ventricle may be searched by exhaustively scanning the echocardiographic sequence in a 6-D space: (x,y sx,,sy,a,t), where (x,y) is the translational parameter, (sx,sy) is two scale parameter, a is the rotational angle, and t is the frame index. A hierarchical searching method that conservatively prunes the parameter space allows a quick localization of the geometric primitives. This follows the strategy that the parameter space is recursively divided and pruned while searching.

As mentioned earlier, ontological contexts can be utilized to prune the search space as well. It has been argued that context is a rich source of information about an object's identity and proposed an inference algorithm that employs this argument for efficient object detection in real-world scenes. Perspective geometry constraints may be used in pedestrian and car detections. Because medical images are captured under constrained conditions, ontological contexts may be leveraged to yield an efficient yet accurate parsing algorithm.

Referring to the search engine 204; the search engine 204 is a multilevel search engine comprising levels for image indexing, search and retrieval functions, learning and optimization strategies for data with non-stationary statistics, and scalable search architectures (see FIG. 5A, block 503).

The search engine 204 performs image indexing, search and retrieval functions. In the exemplary field of medical image retrieval, medical images are constrained, often with a known target (e.g., chest CT, or whole-body MRI), known orientations and imaging parameters, and no occlusion (for 3D modalities). In addition, there context information is given with the images, for example, in the RIS, information including DICOM attributes, radiology report, doctor orders, etc. may be given. Further, unlike generic image retrieval where different people see different things from the same picture, in medical image retrieval, there is no need to entertain or to model human subjectivity. Rather, inter- and intra-observer variability is suppressed in the medical domain. Instead of dealing with perceptual semantics, biophysics-based semantics, e.g., a ground truth, is the focus, For medical image, domain specific tasks are common.

Generic image features that are effective for finding “flower gardens”, “certain styles of oil paintings”, or “trademarks”, may not be suitable for finding specific lesions or diseases in medical images. Medical domain knowledge is used extensively to perform a given retrieval task. None of today's retrieval system attacks the issue of generic representation of medical images, image contents, and query targets. In addition, typically, what the doctor is searching for, she herself cannot find or see easily, either due to large volume of data, or subtlety of the targets. In some domains, a computer can find more cancerous lesions than the best of human doctors.

The framework 201 may be implemented as a generic medical image indexing scheme, exploiting the structured nature of objects, e.g., the human body, thus common physiological and pathological modeling can be used to guide the image interpretation and indexing; and using querying semantics that are non-subjective and can be learned or mined. The search engine 204 instantiates the hierarchical content structure (see FIG. 2, block 203) defined based on anatomy and function (both physiological and diseased) in the database 202, and creates a hierarchical indexing structure.

The search engine 204 creates a hierarchical representation of anatomical structures and functional dependencies (from cell to tissue to organ to system); cross-indexes physiological and pathological contents; flexibly indexes structure for easy adaptation to evolution (of human growth, of imaging technology, and of medical research); and achieves run-time efficiency, e.g., fast (approximate) nearest neighbor search.

Referring to learning and optimization strategies for data with non-stationary statistics and the search engine 204, the medical image data, as well as their semantics, are temporally dynamic by nature, because of better performances of new equipments, age growth of populations, emerging of new diseases/treatments, change of natural/social environments, etc. Accordingly, the semantic representation of medical images, e.g. vocabulary and syntax, should be adapted to the evolution of data, for example, to remove out-of-date concepts, modify drifting concepts and augment new concepts. It is therefore essential to develop online learning methods and dynamic probabilistic models to capture the non-stationary statistics of constantly upcoming data.

The search engine 204 further performs online learning and optimization and dynamic probabilistic detection of patterns. Concerning, online learning and optimization: In a dynamic environment, learning machines need to be able to adapt to the change of environment. In contrast to static batch learning & optimization, online learning & optimization can incrementally incorporate the new training data and adapt the model based on the statistics of the new training data, and thus avoid expensive retraining. For example, the definition of a concept (e.g., a disease) can change as more knowledge about it is gained, thus an online medical image classifier (or tagger) can absorb this growing knowledge to refine itself. States may be 203 automatically identified, as well as their dynamics (e.g. birth, death and drifting), and represent the discovered states by semantic elements.

The framework 201 is a scalable search architecture for designing and implementing system architectures that will be able to support scalable medical image search. One reason behind the success of modern Web search engines, such as Google and Yahoo, etc., is their ability to scale with both the explosive growth of the Web and the exponential use of search engines among users as a means to access information. Central to this scalability has been the design of architectures, including server clusters, content and query caching, replication, compression, indexing, crawling, etc., which can evolve with the size of the Web. However, our medical image search is different in many ways from Web search engines. Since our domain is constrained to medical images, many traditional issues laced by Web search engines, such as crawling, caching, etc. are not applicable to us. On the other hand, the focus on images and content semantics brings their own set of unique requirements.

The search engine 204 further supports service scalability, semantics scalability and image scalability.

Service scalability: since user search requests will be serviced from centralized servers, it is important to develop server architectures that will be able to handle large volumes of requests. The two critical service demands on such an architecture will be anytime accessibility and flexible evolution. These demands in turn lead to two major paradigms of server architectures: (a) clusters of servers, and (b) centralized server.

Semantics scalability: A key differentiation of our medical image search, in contrast to current Web search engines, is the representation and use of content semantics. This induces a novel requirement of metadata storage in persistent systems so that run-time queries can be efficiently answered. RDF (Resource Description Framework) is an exemplary metadata representation language. Commercial databases, such as Oracle 10 g, as well as niche databases such as rdfDB are able to store RDF semantic metadata.

Imaging scalability: To accommodate multiple imaging modalities and potential new modalities, a set of common imaging vocabulary is needed. Using machine learning techniques, a set of common low-level and mid-level image patterns are determined that can be generalized across imaging modalities and with maximum expressive power for mined query patterns. Unseen queries, constructed using allowable rules, can be supported at run-time if the computational load and latency are tolerable.

Creating knowledge repository 208 includes facilities for using image semantics to improve the design and performance of medical knowledge repositories. Medical knowledge repositories store many different kinds of files, such as medical images, clinical documents, administrative spreadsheets, or project management reports, as well as the associated metadata describing the semantics of the files. Links between files and documents can be expressed by using semantic relationships. The precise semantics of the metadata and semantic relationships is specified by underlying ontologies.

By integrating data, metadata and ontologies, sophisticated applications can be realized. The focus of this module is to investigate how analytic functions of medical knowledge repositories, such as cohort identification, patient/disease categorization, clinical care pattern extraction, or disease treatment analysis, can be improved. This will be realized by establishing use cases demonstrating the benefits of integrating image representations and clinical patient data in medical knowledge repositories.

Referring to the integration with other clinical and biomedical data sources, clinical data sources and semantic image data may be modeled and integrated (semantically) with intelligent medical search applications to establish an integrated data model and knowledge model encompassing clinical and semantic image data, and to use the developed data model and knowledge model as basis for the creation an intelligent medical search application prototype (e.g. a clinical routine or research application based on intelligent search functionalities, such as clinical decision support systems, clinical trials, and epidemiological studies).

Clinical and medical domain information may be viewed by integrating image semantics with clinical and medical terminologies,. Ontologies are used for the formal representation of the relevant clinical and medical domain, for improved communication of domain concepts among domain components, and to assist the semantic integration process.

The ontology-guided semantic integration will be realized in three steps: knowledge identification, knowledge specification, and knowledge refinement.

The knowledge identification includes the survey of knowledge items and preparation of the knowledge items in such they can be used for an integrated data- and knowledge model specification. When starting to develop an integrated data- and knowledge model, it is assumed that a knowledge-intensive task has been selected. Based on the task definition, the relevant knowledge items involved in this task can be identified.

To get a complete specification of the integrated data- and knowledge-model by specifying a knowledge-intensive task and constructing an initial integrated knowledge model (using all the reusable knowledge items and structures identified in the Knowledge identification step). For linking the domain and task knowledge, inference knowledge will be used.

Knowledge refinement validates and refines the knowledge model by implementing an intelligent search application prototype.

The framework 201 may be extended to other non-medical imaging, including General methods. The scalable and hierarchical image information representation is extensible to other non-medical domains. One such domain is sport image/video analysis. Low-level feature representations that are customized to the domain of interest are introduced, apart from those generic representations. Because sports are often played on specialized courts/fields, the low-level features can be tuned to suppress the irrelevant background information. The image parsing algorithms can be also customized to accommodate the domain knowledge.

A domain-specific ontology may be constructed. If soccer videos are processed, the natural syntactic objects are players and referees. Semantics can be used to model activities (either intra-team or inter-term), such as scoring, passing, free kick, etc. This requires adapting the mapping from the hierarchical image representation to the semantic ontology.

If an ontological mapping from the medical domain to non-medical domain can be established, we can simply export the searching capabilities developed for medical images to deal with non-medical images, without any trouble.

Thus, representations, both image and ontology, may be extended to the whole computer vision field.

Having described embodiments for a system and method for scalable semantic image searching, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer-implemented system for searching a plurality of images for an image of interest comprising:
a database of semantic image representations linking a semantic model of clinical properties, a syntactic model of high level image properties and an image vocabulary of low level image properties,
a set of queries associated with the semantic image representations; and
a semantic search engine, embodied as computer readable code executed by a processor, for receiving a search query, selecting at least one of the set of queries based on the search query, and searching the plurality of images for the image of interest by comparing the plurality of images against the semantic image representations associated with a selected query.

2. The computer-implemented system of claim 1, wherein a plurality of meta-models, including the semantic model and syntactic model, integrate ontologies that distinguish different semantic views of the plurality of images.

3. The computer-implemented system of claim 1, wherein the search engine is multi-dimensional, semantically integrating image, clinical, and bio-medical information.

4. The computer-implemented system of claim 1, further comprising a computer system supporting the system for searching a plurality of images, wherein the computer system is deployed on a grid platform and the semantic image representations are stored across the grid.

5. The computer-implemented system of claim 1, further comprising a semantic computer aided diagnostics (CAD) module.

6. The computer-implemented system of claim 1, further comprising a decision support systems (DSS) module.

7. The computer-implemented system of claim 1, wherein the database of semantic image representations are arranged hierarchically.

8. The computer-implemented system of claim 1, further comprising means for inputting a query comprising one of images or keywords associated with semantic concepts.

9. A computer readable medium embodying instructions executable by a processor to perform a method for constructing a database of semantic image representations, the method steps comprising:
defining hierarchical representations of an image domain;
defining a query language comprising a plurality of queries available to a search engine; and
associating the queries to the hierarchical representations, wherein the associated queries and hierarchical representations are stored in the database as the semantic image representations.

10. The method of claim 10, further comprising searching a plurality of images for an image of interest by comparing the plurality of images against the semantic image representations, wherein the searching is performed by a semantic search engine that receives a search query, selects at least one of the plurality of queries based on the search query, and determines the image of interest based on a selected query.

11. The method of claim 9, wherein the plurality of queries include a text based query.

12. The method of claim 9, wherein the plurality of queries include an image based query.
